(19) United States
(12) Patent Application Publication
(10) Pub. No.: US 2024/0242003 A1
(43) Pub. Date: Jul. 18, 2024

(54) COMPUTER IMPLEMENTED METHOD OF DETERMINING A TRANSFER FUNCTION OF A MODULE OR A COMPONENT AND GENERATING SUCH COMPONENT

(71) Applicant: Siemens Industry Software NV, Leuven (BE)

(72) Inventor: Theo Geluk, Tholen (NL)

(21) Appl. No.: 18/559,437

(22) PCT Filed: Apr. 11, 2022
(86) PCT No.: PCT/EP2022/059557

§ 371 Date: Nov. 7, 2023

(30) Foreign Application Priority Data
May 11, 2021 (EP) 21173271.4

(51) Int. Cl. G06F 30/17; G01H 17/00

(52) U.S. Cl. CPC G06F 30/17; G01H 17/00

(57) ABSTRACT

A transfer function (TRF) of a module (MDL) is determined. To improve accuracy of such methods, the following acts are used: a. measuring a first set-of-sensors-output (SO1) and a second set-of-sensors-output (SO2) respectively using sensors (SS1, SS2) applied to said module (MDL), b. identifying parameters (ICH) relating to mass and/or inertia and/or damping and/or stiffness of said module (MDL) by rigid body estimation (RBE) from said measurements, c. fitting a first model (RB1) to identified inertia characteristics/parameters (ICH), d. generating a synthetic second set-of-sensors-output (ST2) of said second set-of-sensors (SS2) by said first model (RB1), e. comparing said synthetic second set-of-sensors-output (SO2) with said measurements, and f. estimating a Euler-angle correction (EAC) for said second set-of-sensors (SS2).

### RELATED APPLICATION

The present patent document is a § 371 nationalization of PCT Application Serial Number PCT/EP2022/059557, filed Apr. 11, 2022, which claims priority to EP 21173271.4, filed May 11, 2021, which are hereby incorporated by reference.

### FIELD

The present embodiments relate to a computer implemented method of generating a component including a computer implemented method of determining a transfer function of a component by frequency-based substructuring, wherein in said component at least two modules are combined.

Frequency Based Substructuring [FBS]—also called dynamic substructuring—is a method widely used in the industry for assembling module transfer functions, more specifically Frequency Response Functions [FRFs] to determine the complete system respectively complete component's dynamic behavior. Its advantages include: a) enabling rapid evaluation of the complete dynamic behavior of the system when changing individual, subsystems/components, allowing for a faster design cycle, b) combining analytical/numerical model with measured components for hybrid analysis, and c) convenient workaround if a system/component is difficult to measure.

### BACKGROUND

Most methods devised for FBS require matrix inversion of the measured FRF matrices, which are involved in the coupling of individual components. As errors introduced by measurement propagate, these errors become a major obstacle to obtaining accurate results.

A computer implemented method of determining a transfer function of a module is known from Venugopal Harikrishnan: “Component-Based Transfer Path Analysis and Hybrid Substructuring at high frequencies”, DEGREE PROJECT IN INDUSTRIAL ENGINEERING AND MANAGEMENT, 5 Oct. 2020 (2020-10-05), pages 1-110, XP055854340, STOCKHOLM, SWEDEN. This teaching significantly differs from the current embodiments by:
assumes perfectly known locations, orientations of both the inputs (forces) and outputs (accelerations), and
the assumption that sensor position, rigid body properties, mass and position and orientation of the input forces are known.

In most practical testing situations, these assumptions are not feasible.

Conventionally, accuracy problems resulting from measurement being amplified by post measurement processing include the following approaches:
a. Averaging of upper and lower triangle of the FRF-coupling matrices results in reciprocal coupling terms in the FRF matrix. This may suppress inversion problems, but it does not fundamentally solve the reason why upper and lower triangle components in the FRF matrix are non-reciprocal. The result can still be error prone, as the averaging result is fully dependent on the ‘errors’ made in either the upper or the lower triangle matrix;
b. Removal of non-reciprocal terms in the coupling matrix may—as above stabilize the inversion but does not solve the underlying problem;
c. Fitting a model through the measured transfer function and imposing reciprocal behavior on this model to synthesize a reciprocal coupling matrix. As above, this can stabilize the inversion, but fully maintains the errors present in the coupling matrix. The coupling results are unlikely to be improved;
d. From “Evaluation of the FRF based substructuring and modal synthesis technique applied to vehicle FE data, January 2000, K. Cuppens, P. Sas, L. Hermans” a fundamental FRF based substructuring methodology is known.
e. “Road Noise assessment using component-based TPA for a tire, 2018, F. Bianciardi, J. Ortega Almiron, E. Risaliti, P. Corbeels” is a more recent reference on using FBS in context of component transfer path analysis [TPA] aiming to maximize the coupling quality;
f. Further, Euler angle identification is done in literature, for example involving inertial measurement units (DC accelerometers, gyroscopes, magnetometers). This is known from e.g., “Diversified redundancy in the measurement of Euler angles using accelerometers and magnetometers, 2007, Chirag Jagadish; Bor-Chin Chang”.

It is one object of the current embodiments to improve the accuracy of determining FRF and the accuracy of FBS and to finally improve the quality of components generated on basis of these procedures.

### SUMMARY

To avoid above referenced problems of inaccuracy, a method according to the incipiently type with the features is provided:
a. measuring a first set-of-sensors-output using a first set-of-sensors applied to said module and measuring a second set-of-sensors-output using a second set-of-sensors applied to said module,
b. identifying parameters relating to mass, inertia, damping, and/or stiffness of said module by rigid body estimation from said measurements,
c. fitting a first model to identified inertia characteristics/parameters, enabling a determination of a synthetic second set-of-sensors-output of said second set-of-sensors from said first set-of-sensors-output of said first set-of-sensors,
d. generating a synthetic second set-of-sensors-output of said second set-of-sensors by said first model,
e. comparing said synthetic second set-of-sensors-output with said measured second set-of-sensors-output, resulting in determining a first difference, and
f. estimating a Euler-angle correction for said first set-of-sensors by minimizing the first difference.

The dependent claims describe advantageous developments and modifications.

Said module may be any kind of component feasible to be assumed as a rigid body. The module is to be assumed to be a rigid body by a skilled artisan considering the respective circumstances underlying the analysis. The rigid body estimation in act (b) may be done according to the above mentioned e.g., Huang, Sheng-Jun & Lallement. The skilled artisan has access to numerous publications proposing possibilities of rigid body estimation to determine mass, inertia, damping, and/or stiffness.

Said first set of sensors may preferably include or consist of at least one of a ceramic piezoelectric sensor, an accelerometer, an optical vibrometer, or the like. Said accelerometer may be a sensor that measures the dynamic acceleration of a physical device as a voltage. Using optical laser probes may be advantageous when having light or delicate structure devices or in case of problems to physically contact the device.

Said second set of sensors may preferably include or consist of at least one of a piezoelectric sensor or strain-gauge sensor or the like. Said accelerometer may be a sensor that measures the dynamic acceleration of a physical device as a voltage. Using optical laser probes may be advantageous when having light structure devices or in case of problems to physically contact the device.

The method of rigid body estimation is known from e.g., Huang, Sheng-Jun & Lallement, G. (1997), “Direct Estimation of Rigid Body Properties from Harmonic Forced Responses”.

The estimated mass, inertia, damping, and/or stiffness parameters are used to determine a first model, which may preferably be based on a rigid body model. This first model is fitted to the acquired FRF data from the measurements.

The first model enables determination of a synthetic second set-of-sensors-output from said first set-of-sensors-output of said first set-of-sensors—e.g., inputting force-related parameters (equivalent to an impact of a shaker, hammer, or the like on the module) and receiving vibration related output (equivalent to resulting vibration from this input/excitation).

This first model output may be of varying quality and/or accuracy as reflecting the real vibration result depending on the model input parameter range. Preferably, the first model input parameter ranges being likely to result in higher accuracy output of said first model are selected. Preferably, the frequency of the input in said first model is selected such that the rigid body motion lies below, preferably lies far (at least factor 2) below, the frequency range of the elastic modes. The frequency range of the elastic modes may be estimated or tested before.

From said comparison of said synthetic second set-of-sensors-output with said measured second set-of-sensors-output, a first difference may be determined. This difference may be expressed as a function of Euler-angle-alignment of the second sensor set.

From this difference—or difference function—estimating a Euler-angle correction for said first set-of-sensors may therefore result in finding a minimum, preferably, an absolute minimum of a function (difference or difference-function). Several tools are available for solving this numerical task.

One important understanding is that the misalignment of the Euler angles of the exciters and sensors (shaker, accelerometer, etc.) poses a significant threat to the overall quality of the FRFs and an even more significant problem for the accuracy of the FBS-synthesized FRFs. One reason for said sensitivity may lie in an error amplification effect like that a 5% of error in a single module FRF, e.g., a tire FRF, may result in more than 10% change in a two-module-component FRF based on the coupling of e.g., two module FRFs. Consequently, Euler angle alignment requires a higher order of accuracy, which implies that even the most experienced engineers cannot satisfy sensor alignment accuracy requirements to obtain FRFs accurate enough for FBS-synthesis.

For additional accuracy of the module's FRF determination, the determination of excitation of the module may be improved in accuracy, too. To eliminate the potential error on both process interfaces (excitation, response), it is proposed to perform the additional acts of:
g. determining a second model enabling a determination of said first set-of-sensors-output from said second set-of-sensors-output of said second set-of-sensors,
h. generating a synthetic first set-of-sensors-output of said first set-of-sensors by said second model,
i. comparing said synthetic first set-of-sensors-output with said measured first set-of-sensors-output determining a second difference, and
j. estimating a Euler-angle correction for said second set of sensors by minimizing the second difference.

The second model may be an inverse model of said first model to enable the reciprocal process of determining the synthetic first set-of-sensors-output from inputting said second set-of-sensors-output. Since the Euler-angle correction according to act j. is done subsequently to act f.'s, Euler angle correction act j. may preferably be done based on applying said Euler-angle correction and setting the corrected first set-of-sensors-output as first set-of-sensors-output for subsequent acts. Generally, corrected Euler angles may be applied after determination of said correction for subsequent processing for improved accuracy.

The preferred field of application may be modal analysis, and the transfer function may preferably a frequency response function.

These approaches may preferably be used when determining a transfer function, respectively, a frequency response function of a component including several modules by frequency based substructuring, wherein in said component at least two modules are combined, including the acts of:
determining a transfer function of a module applying a method according to the preceding description, and
coupling the obtained transfer functions generating a component transfer function, respectively, frequency response function.

Method acts or sets of method acts according to some approaches may be performed repeatedly, preferably in a recursive manner (successive results respectively are based on at least the preceding result), to improve accuracy of the results.

Further, the approach relates to a computer implemented method of generating a component including the method according to the preceding description. The method, preferably, may include:
defining a should-state of a transfer function of said component, selecting at least one design parameter of a module (MDL) of said component (CMP) to be changed to influence the transfer function of said component (CMP),
performing and/or repeating the following process acts (I).-(IV). for said selected design parameter(s) until said transfer function of said component (CMP) complies with the should-state:
   (I). selecting one of said selected design parameter(s),
   (II). performing said method of determining a transfer function of a component by frequency-based substructuring,
   (III). changing said selected design parameter and performing the method of determining a transfer function of a component by frequency-based substructuring with the changed design parameter,
   (IV). comparing the transfer functions of the component before and after changing said design parameter, and generating said component with changed design parameters.

Further, the approach relates to a computer or system being adapted to carrying out a method of the above defined type.

Further, the approach relates to a computer-readable medium encoded with executable instructions, that when executed by a processor or computer, cause the above referenced computer or system to carry out a method.

In general, a computer-implemented method is one that involves the use of a computer, computer network, or other programmable apparatus, where one or more features are realized wholly or partly by a computer program. Every method act may be understood in the light of the description by a person with ordinary skill in the art to be done as a computer-implemented act of the method. The computer-implemented method may contain some acts to be done without the computer.

Advantageous configurations and embodiments of the method follow from the claims as well as aspects of the following descriptions.

### BRIEF DESCRIPTION OF THE DRAWINGS

Embodiments are now described, by way of example only, with reference to the accompanying drawings, of which:

FIG. 1 (FIGS. 1A-C) shows an example schematic diagram illustrating the method-acts and the system;

FIG. 2 schematically shows an example of the effect of the method illustrated symbolically by sensor alignment;

FIG. 3 compares example diagrams of an uncorrected transfer function and corrected transfer function (respectively level and phase);

FIG. 4 illustrates schematically Frequency Based Substructuring [FBS];

FIG. 5 (FIGS. 5A-E) schematically illustrates the method of generating a component according to one approach.

The illustration in the drawings is in schematic form, respectively. It is noted that in different figures, similar or identical parameters may be provided with the same reference signs.

### DESCRIPTION OF THE DRAWINGS

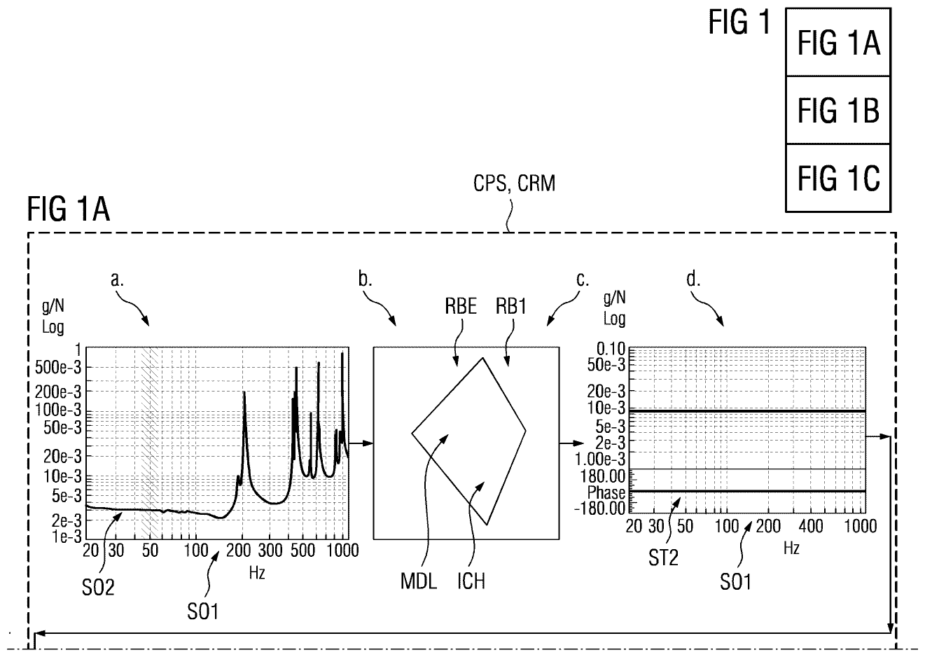

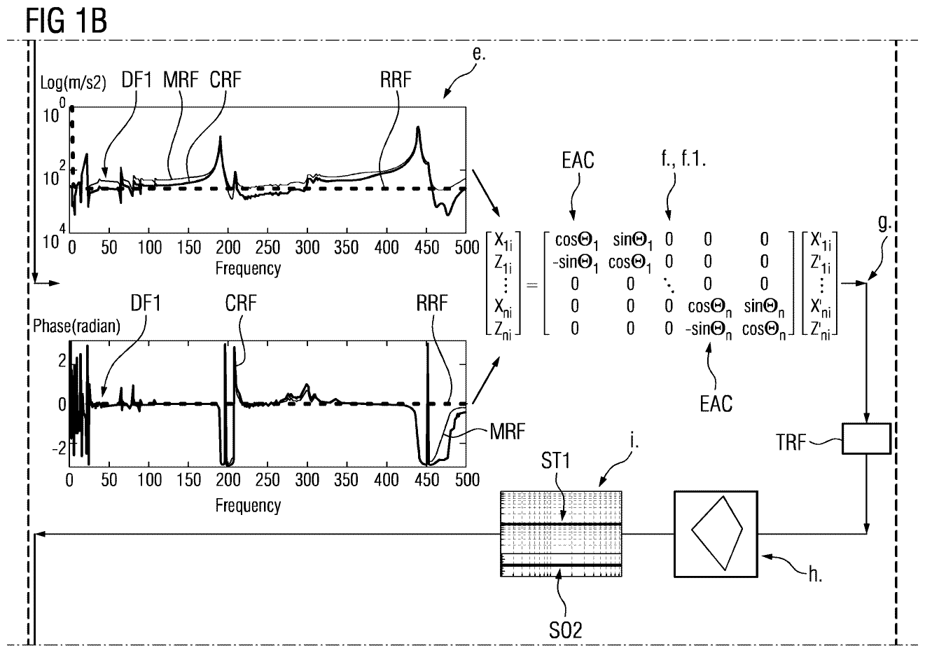

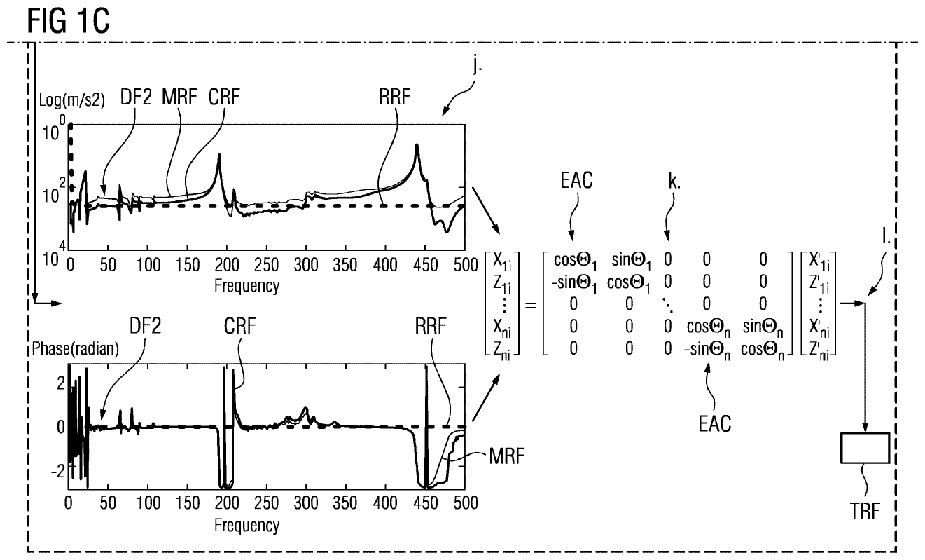

FIG. 1 shows a schematic illustration of the method-acts as well as a computer-system CPS and a computer readable medium CRM encoded with executable instructions, that when executed, cause the computer system CPS to carry out the method. The computer system CPS may be a personal computer, a computer network including computational resources, or a mobile device or similar computer.

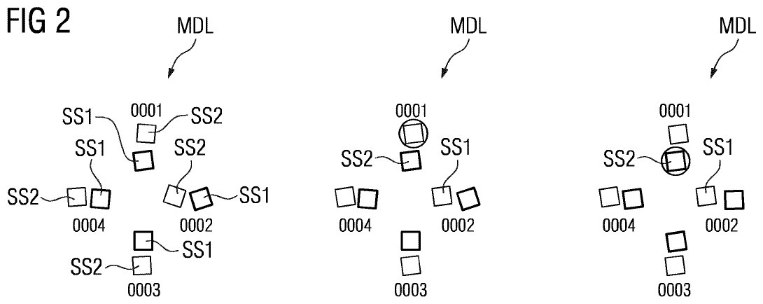

FIG. 1 illustrates said computer implemented method of determining a transfer function TRF of a module MDL including the acts:
a. measuring a first set-of-sensors-output SO1 using a first set-of-sensors SS1 (shown in FIG. 2) applied to said module MDL and measuring a second set-of-sensors-output SO2 using a second set-of-sensors SS2 (shown in FIG. 2) applied to said module MDL,
b. identifying parameters ICH relating to mass, inertia, damping, and/or stiffness of said module MDL by rigid body estimation RBE from said measurements,
c. fitting a first model RB1 to identified inertia characteristics and/or parameters ICH, enabling a determination of a synthetic second set-of-sensors-output ST2 of said second set-of-sensors SS2 (shown in FIG. 2) from said first set-of-sensors-output SO1 of said first set-of-sensors SS1 (shown in FIG. 2),
d. generating a synthetic second set-of-sensors-output ST2 of said second set-of-sensors SS2 (shown in FIG. 2) by said first model RB1,
e. comparing said synthetic second set-of-sensors-output SO2 with said measured second set-of-sensors-output SO2 determining a first difference DF1,
f. estimating a Euler-angle correction EAC for said first set-of-sensors SS1 by minimizing the first difference DF1, f.1, and correcting said measured first set-of-sensors-output SO1 by applying said Euler-angle correction EAC and setting the corrected first set-of-sensors-output SO1 as first set-of-sensors-output SO1 for subsequent acts.

Further the method illustrated includes the acts of:
g. determining a second model RB2 enabling a determination of said first set-of-sensors-output SO1 from said second set-of-sensors-output SO2 of said second set-of-sensors SS2 (shown in FIG. 2),
h. generating a synthetic first set-of-sensors-output SO1 of said first set-of-sensors SS1 (shown in FIG. 2) by said second model RB2,
i. comparing said synthetic first set-of-sensors-output SO1 with said measured first set-of-sensors-output SO1 determining a second difference DF2,
j. estimating a Euler-angle correction EAC for said second set of sensors SO2 by minimizing the second difference DF2, and
j.1. correcting said measured second set-of-sensors-output SO2 by applying said Euler-angle correction EAC and setting the corrected second set-of-sensors-output SO2 as said second set-of-sensors-output SO2 for subsequent acts.

FIG. 2 shows the effect of the method acts. Before correction of the Euler angles Q, said second set-of-sensors SS2 and first set-of-sensors SS1 are basically in a random individual alignment (manually done)—not sufficiently accurate aligned to each other. After applying the acts a.-f., the sensors of said second set of sensors SS2 are algorithmically aligned to each other by Euler angle correction EAC. After applying the additional method acts g.-j., the sensors of said first set of sensors SS1 are aligned to each other and are aligned to said second set of sensors SS2.

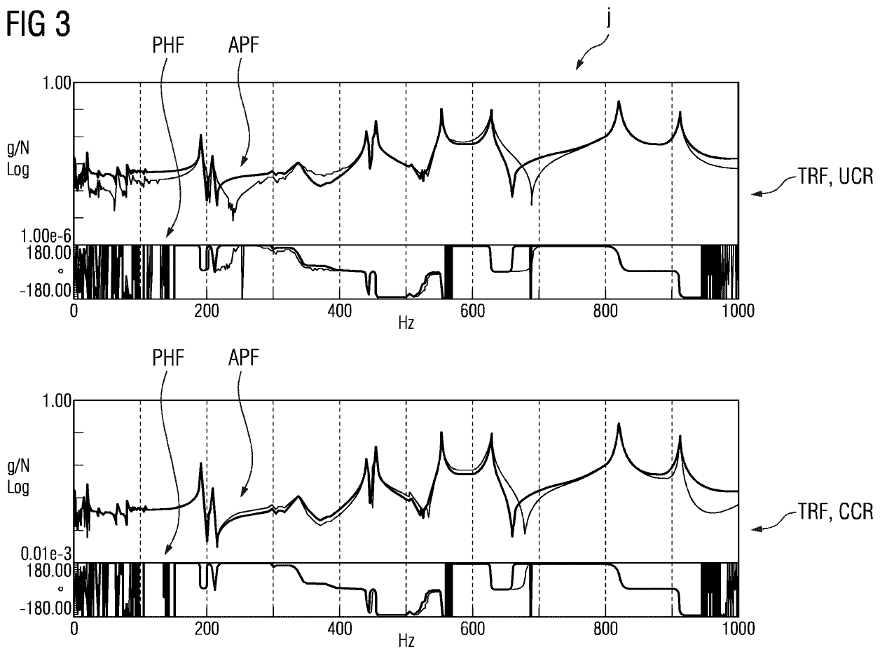

FIG. 3 shows the uncorrected transfer function TRF in the upper part and the corrected transfer function TRF (both being a frequency response function FRF) in the lower part, respectively, an intensity-function and the phase-function of the frequency. The corrected transfer function TRF shows a smaller deviation between the measurements of the single sensors.

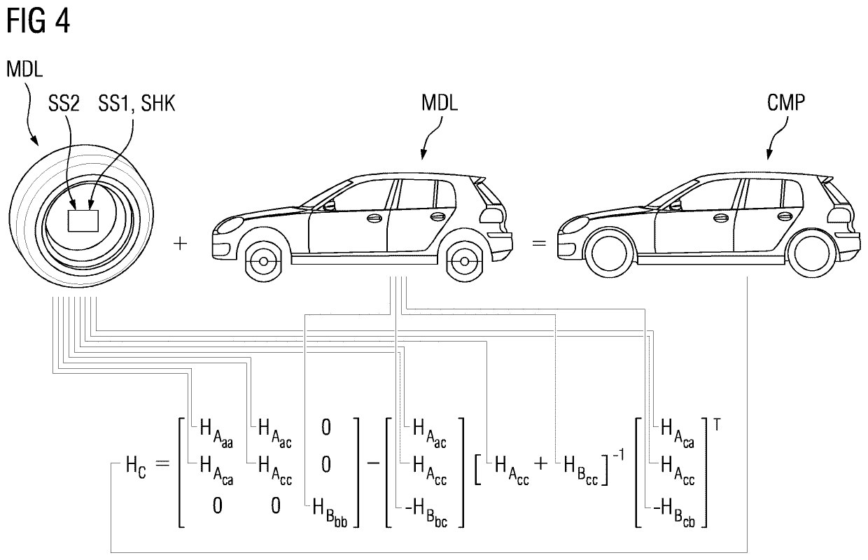

FIG. 4 illustrates schematically Frequency Based Substructuring [FBS] combining two modules MDL (four tires=first module MDL, the rest of the vehicle without tires=second module MDL) to result in the complete component CMP. The first module MDL, respectively, the tires are equipped with the second set of sensors SS2, and a shaker SHK includes a first set of sensors SS1. For example, the second set of sensors may include nine accelerometers to monitor the vibrations caused by the shaker SHK. Since the tire center does not physically exist due to the hole for the vehicle-axle, the sensors of the second set of sensors SS2 are normally arranged around the hole. The second module MDL of the component CMP may be equipped with sensors sets, too, and the method according to one approach may be applied there as well. The overall transfer function TRP is a frequency response function FRF and may be obtained by combining the two transfer functions TRP of the modules MDL involved, as illustrated below the pictures of the vehicle, respectively, the tire. as an equation of matrices. The contributions of the single transfer functions TRP of the respective modules MDL to the transfer function TRF of the complete component CMD is indicated by lines drawn between the respective module MDL and the metrics equation elements below the pictures (tire parameters are indicated by subscripted ‘A’, rest-vehicle parameters are indicated by subscripted ‘B’, component parameters are indicated by subscripted ‘C’). When combining the single transfer functions TRP it becomes necessary to make a matrix inversion (circled term) that leads to error-amplification. If the single transfer functions TRP of the modules MDL to be combined are not sufficiently accurate, the error amplification may lead to inacceptable results. In this context, the correct Euler angle alignment is essential, and the correction introduced by the approach of high importance.

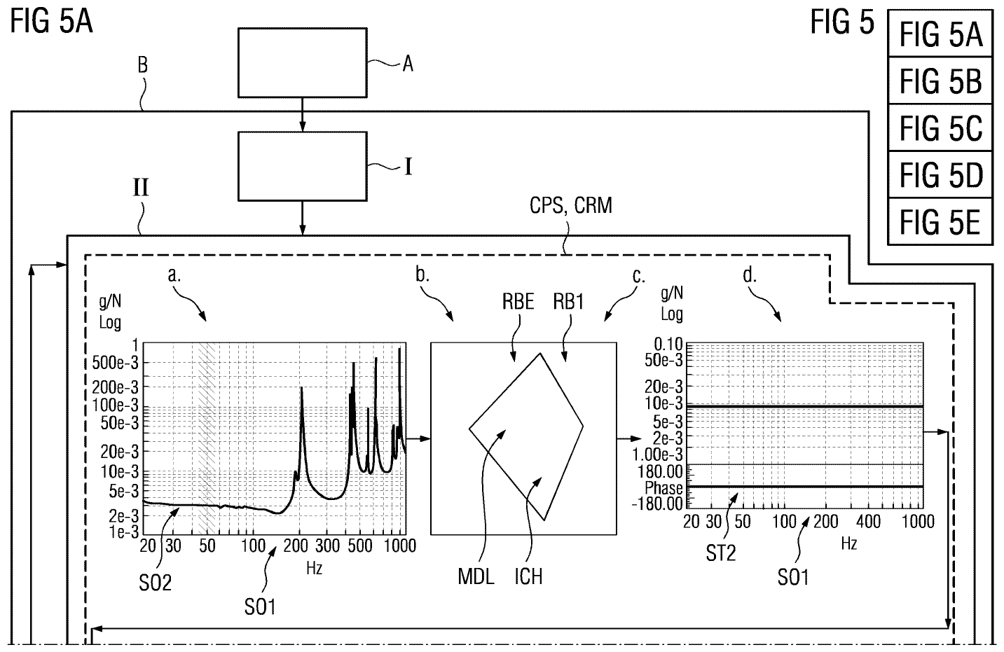

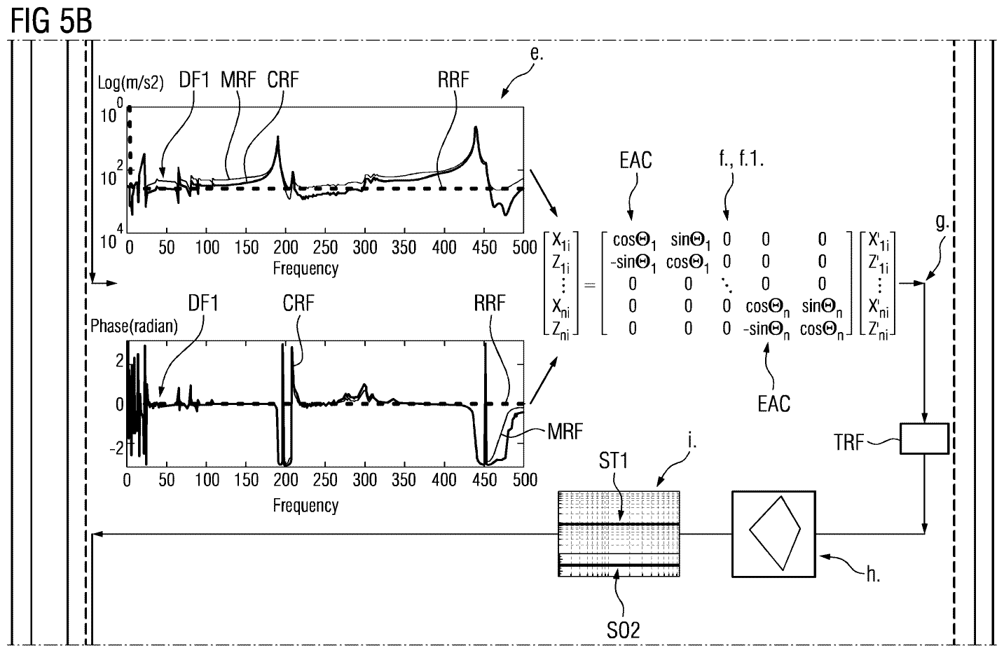

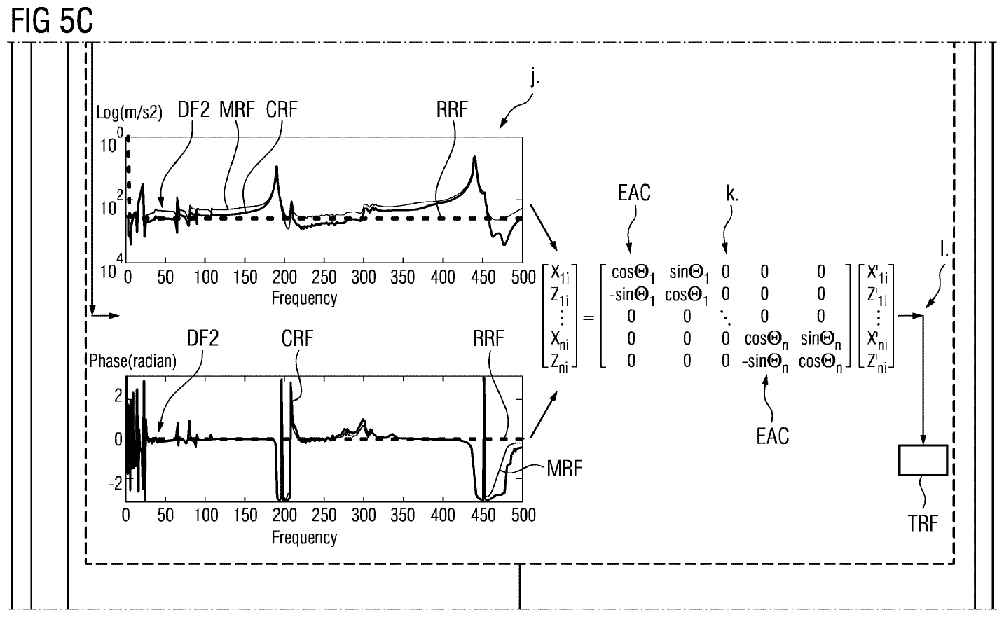

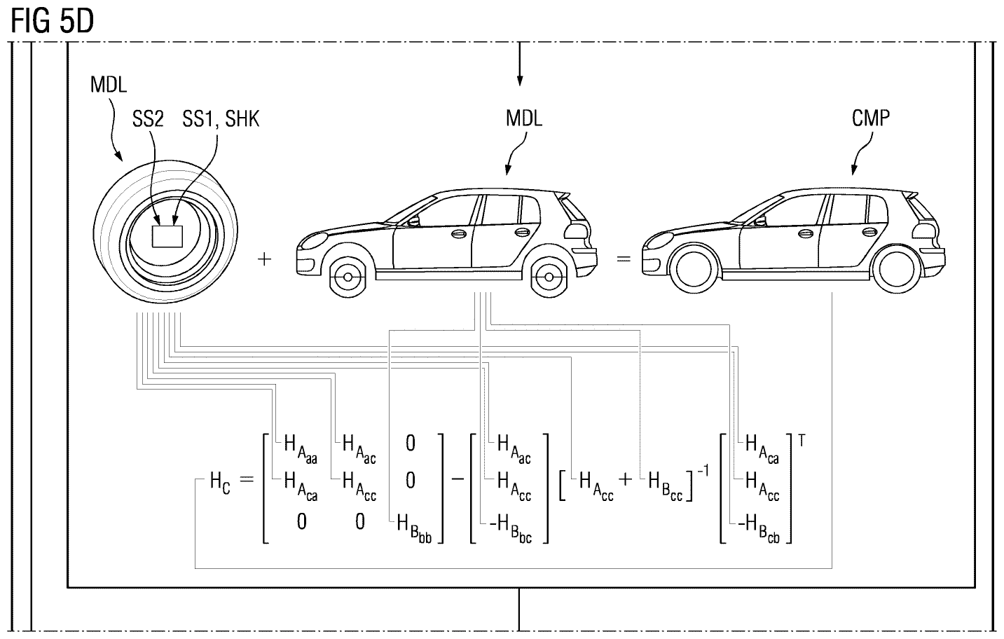

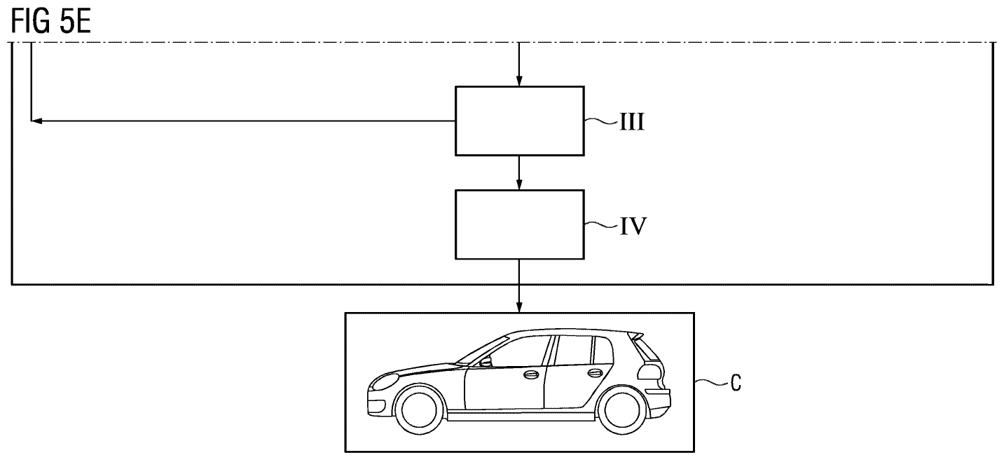

FIG. 5 schematically illustrates a computer implemented method of generating a component CMP. Initially, a should-state of a transfer function of said component may be defined, like low noise in a vehicles compartment when driving along a specific road paving roughness.

In an act A. at least one design parameter of a module MDL of said component CMP to be changed to influence the transfer function of said component CMP is selected.

During act B. the following process acts (I).-(IV) are performed or repeated for said selected design parameter(s) until said transfer function of said component (CMP) complies with the predefined should-state:
(I). selecting one of said selected design parameter(s),
(II). performing the method of determining a transfer function of a module (MDL) by a computer implemented method including the acts a.-f.,
(III). changing said selected design parameter and performing the method of determining a transfer function of a module (MDL) by a computer implemented method including the acts a.-f. with the changed design parameter,
(IV). comparing the transfer functions of the component (CMP) before and after changing said design parameter.

During a final act C. said component with changed design parameters is generated.

Although the present invention has been described in detail with reference to the preferred approaches, it is to be understood that the present invention is not limited by the disclosed examples but by the scope defined by the claims, and that numerous additional modifications and variations could be made thereto by a person skilled in the art without departing from the scope of the invention defined by the independent claims.

It should be noted that the use of “a” or “an” throughout this application does not exclude a plurality, and “comprising” does not exclude other acts or parameters. Also, parameters described in association with different embodiments may be combined. It should also be noted that reference signs in the claims should not be construed as limiting the scope of the claims.

1-12. (canceled)

13. A computer implemented method of determining a transfer function of a component by frequency based substructuring, wherein, in said component, at least two modules are combined, the method comprising:
determining a transfer function of a module by a computer implemented method comprising:
a. measuring a first set-of-sensors-output using a first set-of-sensors applied to said module and measuring a second set-of-sensors-output using a second set-of-sensors applied to said module,
b. identifying parameters relating to mass, inertia, damping, and/or stiffness of said module by rigid body estimation from said measurements,
c. fitting a first model to the identified inertia parameters, the fitting enabling a determination of a synthetic second set-of-sensors-output of said second set-of-sensors from said first set-of-sensors-output of said first set-of-sensors,
d. generating a synthetic second set-of-sensors-output of said second set-of-sensors by said first model,
e. comparing said synthetic second set-of-sensors-output with said measured second set-of-sensors-output, the comparing resulting in determination of a first difference,
f. estimating a Euler-angle correction for said second set-of-sensors by minimization of the first difference,
defining a should-state of the transfer function of said component,
selecting at least one design parameter of the module of said component to be changed to influence the transfer function of said component,
performing and/or repeating the following process acts (I).-(IV). for said selected at least one design parameter until said transfer function of said component complies with the should-state:
(I). selecting one of said selected at least one design parameter,
(II). performing the method of determining the transfer function of the module by a computer implemented method comprising the steps a.-f. and coupling transfer functions of said modules of said component, obtaining a component transfer function,
(III). changing said selected at least one design parameter and performing the method of determining the transfer function of the module by a computer implemented method comprising the steps a.-f. and coupling transfer functions of said modules of said component, obtaining a component transfer function, with the changed design parameter, and
(IV). comparing the transfer functions of the component before and after changing said design parameter, and
generating said component with changed design parameters.

14. The method according to claim 13, wherein the determining of the transfer function of the module comprises the additional acts of:
g. determining a second model enabling a determination of said first set-of-sensors-output from said second set-of-sensors-output of said second set-of-sensors,
h. generating a synthetic first set-of-sensors-output of said first set-of-sensors by said second model,
i. comparing said synthetic first set-of-sensors-output with said measured first set-of-sensors-output, resulting in determination of a second difference, and
j. estimating a Euler-angle correction for said first set of sensors by minimization of the second difference.

15. The method according to claim 13, wherein act f. comprises correcting said measured first set-of-sensors-output by applying said Euler-angle correction and setting the corrected first set-of-sensors-output as first set-of-sensors-output for subsequent acts.

16. The method according to claim 14, wherein act j comprises:
j.1. correcting said measured second set-of-sensors-output by application of said Euler-angle correction and setting the corrected second set-of-sensors-output as said second set-of-sensors-output for subsequent acts.

17. The method according to claim 14, wherein said second model is an inverse model of said first model.

18. The method according to claim 13, wherein said first set-of-sensors comprises vibration sensors and wherein said first set-of-sensors-output comprises vibration characteristics.

19. The method according to claim 13, wherein said second set-of-sensors comprises force sensors, and wherein said second set-of-sensors-output comprises excitation force characteristics.

20. The method according to claim 13, wherein said transfer function is a frequency response function.

21. The method according to claim 17, wherein said first set-of-sensors comprises vibration sensors and wherein said first set-of-sensors-output comprises vibration characteristics.

22. The method according to claim 21, wherein said second set-of-sensors comprises force sensors, and wherein said second set-of-sensors-output comprises excitation force characteristics.

23. The method according to claim 22, wherein said transfer function is a frequency response function.

24. A computer system comprising:
a first set of sensors;
a second set of sensors;
a computer configured to:
determine a transfer function of a module by:
a. measure a first set-of-sensors-output using the first set-of-sensors applied to the module and measure a second set-of-sensors-output using the second set-of-sensors applied to the module,
b. identify parameters relating to mass, inertia, damping, and/or stiffness of said module by rigid body estimation from said measurements,
c. fit a first model to the identified inertia parameters, the fit enabling a determination of a synthetic second set-of-sensors-output of said second set-of-sensors from said first set-of-sensors-output of said first set-of-sensors,
d. generate a synthetic second set-of-sensors-output of said second set-of-sensors by said first model,
e. compare said synthetic second set-of-sensors-output with said measured second set-of-sensors-output, the comparison resulting in determination of a first difference,
f. estimate a Euler-angle correction for said second set-of-sensors by minimization of the first difference,
define a should-state of the transfer function of said component,
select at least one design parameter of the module of said component to be changed to influence the transfer function of said component,
perform and/or repeat (I).-(IV). for said selected at least one design parameter until said transfer function of said component complies with the should-state:
(I). select one of said selected at least one design parameter,
(II). determine the transfer function of the module with a.-f. and couple transfer functions of said modules of said component, resulting in a component transfer function,
(III). change of said selected at least one design parameter and determine the transfer function of the module with a.-f. and couple transfer functions of said modules of said component, resulting in a component transfer function, with the changed design parameter, and
(IV). compare the transfer functions of the component before and after changing said design parameter, and
generate said component with changed design parameters.

25. A non-transitory computer-readable medium encoded with executable instructions, that when executed by a computer, cause the computer to:
determine a transfer function of a module by:
a. measure a first set-of-sensors-output using the first set-of-sensors applied to the module and measure a second set-of-sensors-output using the second set-of-sensors applied to the module,
b. identify parameters relating to mass, inertia, damping, and/or stiffness of said module by rigid body estimation from said measurements,
c. fit a first model to the identified inertia parameters, the fit enabling a determination of a synthetic second set-of-sensors-output of said second set-of-sensors from said first set-of-sensors-output of said first set-of-sensors,
d. generate a synthetic second set-of-sensors-output of said second set-of-sensors by said first model,
e. compare said synthetic second set-of-sensors-output with said measured second set-of-sensors-output, the comparison resulting in determination of a first difference,
f. estimate a Euler-angle correction for said second set-of-sensors by minimization of the first difference,
define a should-state of the transfer function of said component,
select at least one design parameter of the module of said component to be changed to influence the transfer function of said component,
perform and/or repeat (I).-(IV). for said selected at least one design parameter until said transfer function of said component complies with the should-state:
(I). select one of said selected at least one design parameter,
(II). determine the transfer function of the module using a.-f. and couple transfer functions of said modules of said component, resulting in a component transfer function,
(III). change said selected at least one design parameter and performance of determination of the transfer function of the module comprising a.-f. and coupling transfer functions of said modules of said component, resulting in a component transfer function, with the changed design parameter, and
(IV). compare the transfer functions of the component before and after changing said design parameter, and
generate said component with changed design parameters.
